(19) United States
(12) Patent Application Publication
(10) Pub. No.: US 2026/0227742 A1
(43) Pub. Date: Aug. 6, 2026

(54) TIMEPIECE COMPRISING A MECHANISM FOR DISPLAYING SUCCESSIVE HOURS IN A DISPLAY ZONE

(71) Applicant: Manufacture d'Horlogerie Audemars Piguet SA, Le Brassus (CH)

(72) Inventors: Laurent CALAME, La Sagne (CH); Ismäel ERDINC, La Chaux-de-Fonds (CH); Aurélien PINA, Grandevent (CH)

(21) Appl. No.: 19/146,798

(22) PCT Filed: Jan. 11, 2024
(86) PCT No.: PCT/EP2024/050618

§ 371 Date: Jul. 9, 2025

(30) Foreign Application Priority Data
Jan. 30, 2023 (EP) 23154071.7

(51) Int. Cl. G04B 19/22; G04B 19/10

(52) U.S. Cl. CPC G04B 19/223; G04B 19/10

(57) ABSTRACT

A timepiece includes a time display mechanism including a support member rotatable about an axis of rotation arranged to perform one revolution in n hours, and carrying n satellites each rotatably mounted on its own axis of rotation, located uniformly distributed about the axis of rotation of the support member and carrying the hour digits, distributed over the satellites, at a rate of 12/n or 24/n digits per satellite, and a time display zone extending over a circular sector of at least 360/n° centered on the axis of rotation of the support member. The assembly is arranged such that the hour digits are successively displaced in order to appear in the display zone.

### TECHNICAL FIELD

The present invention relates to a timepiece comprising a time display mechanism comprising a support member rotatable about an axis of rotation A and arranged to perform one revolution in n hours, n being a whole number greater than 1, and carrying n satellites each rotatably mounted on its own axis of rotation, located uniformly distributed about the axis of rotation A of the support member and carrying the hour digits, distributed over said satellites, at a rate of 12/n or 24/n digits per satellite, and a time display zone extending over a circular sector of at least 360/n° centred on the axis of rotation A of the support member, the assembly being arranged such that the hour digits are successively displaced in order to appear in the display zone to display the hours.

### PRIOR ART

Such a timepiece is described in patent CH 677575 filed by the applicant and is known under the name “Star wheel” which makes it possible to display a wandering hour.

This piece comprises a dial which includes a sector typically of 120° provided with a minute scale which is graduated from 0 to 60. Corresponding to this scale, an hour digit is displaced in sixty minutes while moving over this sector. Thus, the digit indicates the hours and its position on the sector facing the minute scale indicates the minutes of the current hour. Facing the sector of the minute scale, the hour digit is displaced according to an orientation which is strictly radial. In other words, when the hour digit passes along the sector of the minute scale, the orientation of this digit is merged with the radius of the sector which connects the centre of this sector to the minute indicated by this digit on the minute scale.

The mechanism described in patent CH 677575 comprises three discs each carrying 4 hour digits and rotatably mounted at 120° from one another on the felloe of a central wheel performing a revolution in three hours. Thus, on a minute scale curved according to a sector of 120°, the hour digit will revolve by 120° between the start and the end of the sector during its progress facing the minute scale. In order to make it possible to display the next hour digit on a disc, the discs are rotated punctually by a star associated with the centre of each disc and which revolves by a quarter turn when two fixed fingers or pins distributed over the dial pass over it. The angular position of the discs is secured by jumpers engaging the stars.

When the hour digit is oriented in the radial up-down direction, its inclination therefore varies by 120° between the start and the end of its display facing the minute scale such that reading the time can be deemed to not be sufficiently ergonomic.

Furthermore, the system for driving the discs by a star which is actuated by a pin generates a force to make the discs revolve, which is not constant, since it is concentrated punctually at the moment when the stars meet the pins. The disadvantage of this is that it creates awkward dynamic effects generating a disruptive torque.

The present invention aims to remedy these drawbacks by proposing a timepiece which makes it possible to display the time by means of a mobile indicator while making it possible to read the time in an ergonomic manner.

Another object of the present invention is to propose a timepiece which makes it possible to display the time by means of a mobile indicator without generating a disruptive torque.

### DISCLOSURE OF THE INVENTION

To that end, the invention relates to a timepiece comprising a time display mechanism comprising a support member rotatable about an axis of rotation A and arranged to perform one revolution in n hours, n being a whole number greater than 1, and carrying n satellites each rotatably mounted on its own axis of rotation, located uniformly distributed about the axis of rotation A of the support member and carrying the hour digits, distributed over said satellites, at a rate of 12/n or 24/n digits per satellite, and a time display zone extending over a circular sector of at least 360/n° centred on the axis of rotation A of the support member, the assembly being arranged such that the hour digits are successively displaced in order to appear in the display zone.

According to the invention, the support member is constituted by a cage, the satellites are constituted by toothed wheels and are arranged to be continually rotated on themselves about their own axis of rotation in the opposite direction to the direction of rotation of the cage and at a different rotation speed to the rotation speed of the cage by means of intermediate wheels carried by said cage and arranged to be kinematically linked to a fixed wheel with respect to said cage and coaxial to the axis of rotation A of the cage, the rotation speed of each satellite about its own axis of rotation with respect to the cage being selected so as to minimise the apparent angular displacement of said satellite with respect to its own centre of rotation in the display zone during the displacement of said satellite led by the cage between the start and the end of said display zone.

Thus, the apparent inclination of the hour digit in the display zone varies very little between the start and the end of its display such that reading the time is made easier although the hour digit is mobile.

In addition, the meshing of the satellites being permanent, the force to make them revolve is continuous. For this reason, the torque transfer of the system is advantageously smoothed by being substantially constant.

### BRIEF DESCRIPTION OF THE DRAWINGS

Other characteristics and advantages of the present invention will appear on reading the following detailed description of different embodiments of the invention which are provided by way of non-limiting examples, and with reference to the appended drawings, wherein:

FIGS. 1 to 3 are schematic top views of a dial of a timepiece comprising a time display mechanism according to a first embodiment of the invention, said views showing in particular three positions of the hour digit during its displacement between the start and the end of the display zone;

FIG. 4 depicts a top view of a time display mechanism according to a second embodiment of the invention;

FIG. 5 is an isometric view of the time display mechanism from FIG. 4;

FIG. 6 is a front view of FIG. 5;

FIG. 7 is an isometric view of the support member, the satellites and the intermediate wheels according to the second embodiment of the invention from FIGS. 4 to 6;

FIGS. 8 to 11 depict different positions of a mobile revealing device during the displacement of an hour digit between the start and the end of the display zone according to the first embodiment of the invention; and

FIG. 12 depicts a time display mechanism according to another embodiment of the invention.

### EMBODIMENTS OF THE INVENTION

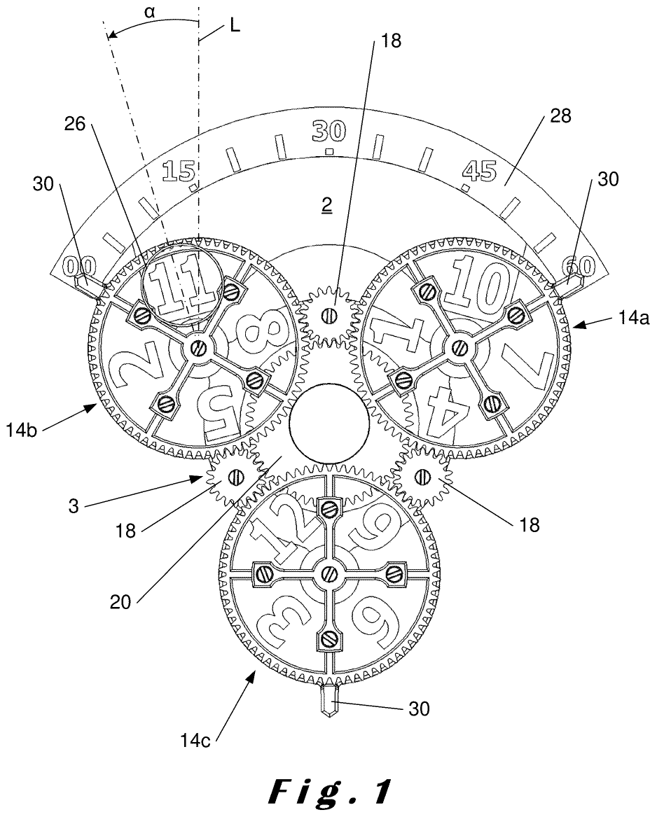

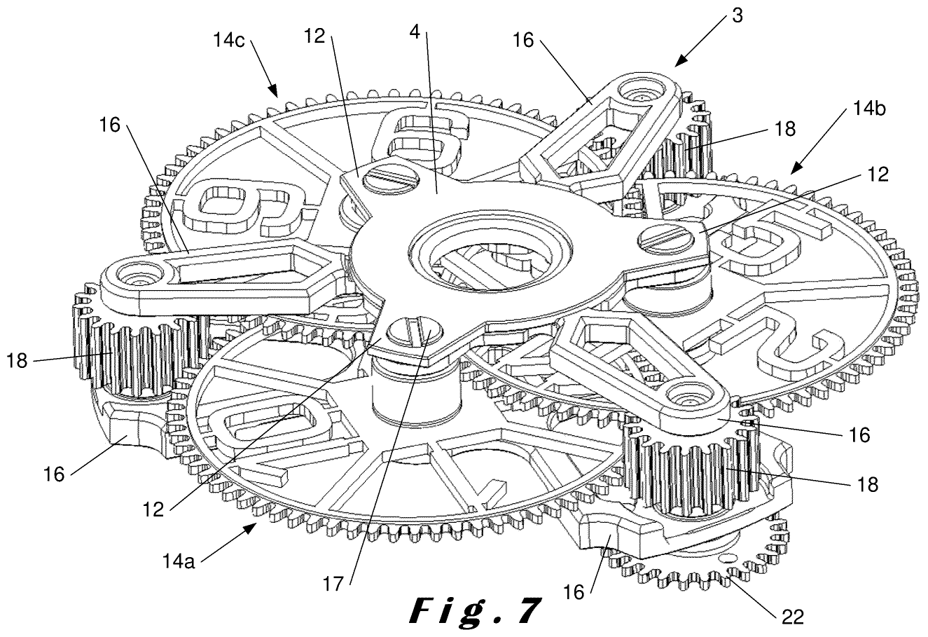

With reference to FIGS. 1 to 7, the present invention relates to a timepiece, such as a wristwatch, comprising a time display mechanism which makes it possible to display the hours on a dial 1, such as the time in GMT, and preferably also the minutes.

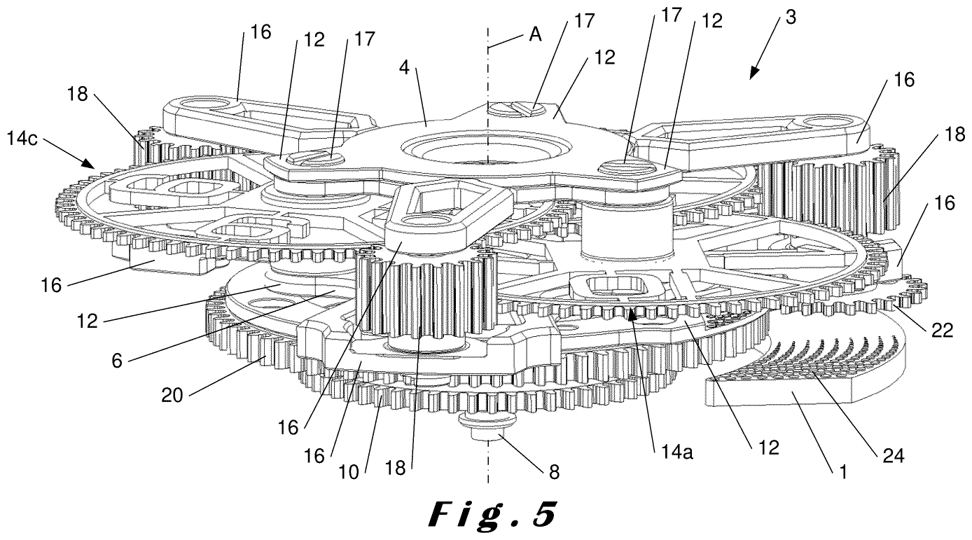

Such a time display mechanism comprises a support member mounted so as to be rotatable about an axis of rotation A (cf. FIG. 5) on a frame element of the timepiece, said support member being arranged to perform one revolution in n hours, n being a whole number greater than 1. In the depicted examples, n is equal to 3.

The time display mechanism also comprises a time display zone 2 provided on the dial 1, extending over a circular sector of at least 360/n°, that is to say typically extending in the examples of the appended figures over a little more than 360/n°, that is to say over a little more than 120° here, centred on the axis of rotation A of the support member, said mechanism being arranged such that the hour digits are successively displaced in order to appear in the display zone 2 to display the hours.

In accordance with the invention, said support member is constituted by a cage 3 intended to be mounted so as to be rotatable about the axis A on a frame element of the watch movement (not depicted) of the timepiece.

The axis of rotation A of the cage 3 can be centred on the dial 1, as depicted here. It is obvious that the axis of rotation A of the cage 3 can be offset with respect to the centre of the dial of the timepiece in the event that the time display is not centred with respect to said dial of the piece.

The cage 3 comprises an upper bridge 4 and preferably a lower bridge 6 which are parallel and integral in rotation. According to the preferred embodiment, the lower bridge 6 is integral with a drive shaft 8 supported by the frame, said drive shaft 8 itself being integral with a drive wheel 10.

In order to rotate the cage 3, the timepiece in particular comprises a motion work (not depicted) arranged to mesh with the drive wheel 10 which rotates the drive shaft 8, and therefore the lower bridge 6 and upper bridge 4.

The upper bridge 4 and lower bridge 6 advantageously have a circular central shape of axis A, at the centre of which a “cabochon” (not depicted) can be positioned. Advantageously, the upper bridge 4 and lower bridge 6 can respectively comprise a first set of n arms 12 directed radially outwards, uniformly distributed, and arranged to carry n satellites 14a, 14b, 14c.

Advantageously, the upper bridge 4 and lower bridge 6 can also respectively comprise a second set of n arms 16 directed radially outwards, uniformly distributed by being inserted between the arms 12, and on which at least n reversing intermediate wheels 18 are pivotally mounted, a reversing intermediate wheel 18 being arranged to cooperate with two successive satellites 14a, 14b, 14c. These reversing intermediate wheels 18 will be described in more detail below.

The dimensions of the cage 3, and in particular of the arms 12 and 16, are selected as a function of the first or second embodiment of the display mechanism.

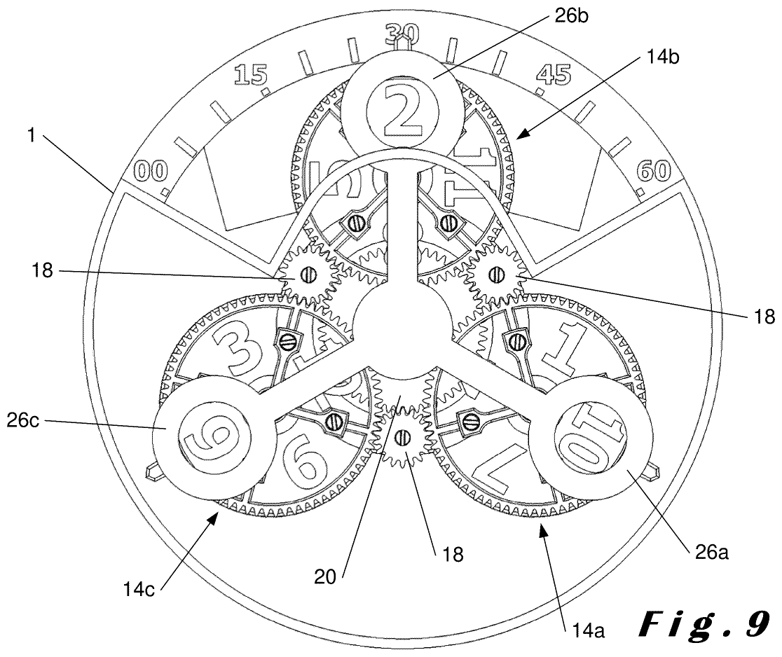

More particularly, in the first embodiment which is depicted in FIGS. 1 to 3 and 8 to 11, the dimensions of the cage 3 and of its arms 12 and 16 are selected to make it possible to locate the satellites 14a, 14b, 14c at regular intervals in a circle centred on the axis of rotation A on a same level, that is to say in a same plane, which corresponds to an extended configuration.

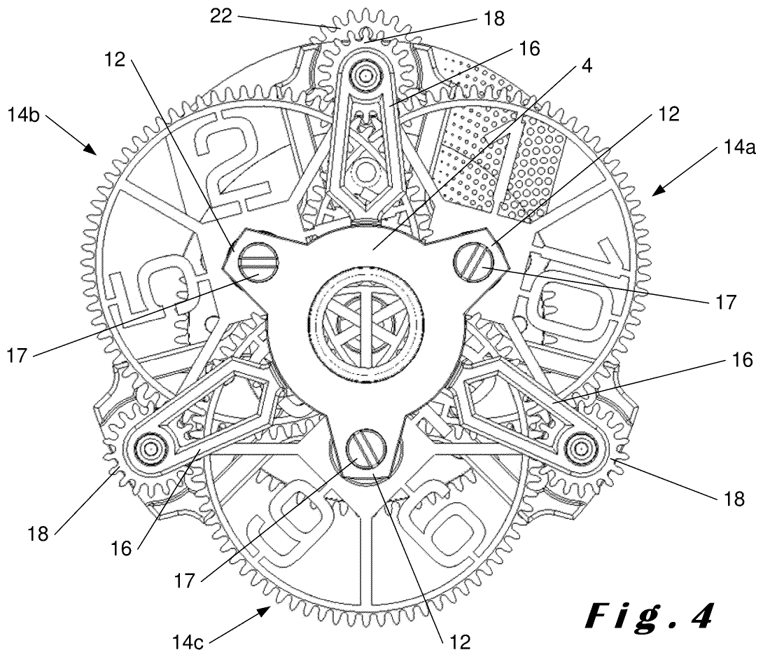

In the second embodiment which is depicted in FIGS. 4 to 7, the dimensions of the cage 3 and of its arms 12 and 16 are selected to obtain a compact configuration by locating the satellites 14a, 14b, 14c in a compact manner in diameter with respect to the axis A, the satellites 14a, 14b, 14c then having to be arranged to be located in a partially superimposed manner with respect to one another.

Each satellite 14a, 14b, 14c is rotatably mounted on its own axis of rotation within the cage, in particular on an axis of rotation mounted between an arm 12 of the upper bridge 4 and a corresponding arm 12 of the lower bridge 6 of the cage 3 by means of screws 17. Thus, the satellites 14a, 14b, 14c are located uniformly distributed about the axis of rotation A of the cage 3 by being coplanar according to the first embodiment, or partially superimposed in parallel planes according to the second embodiment.

The satellites 14a, 14b, 14c carry the hour digits, distributed over said satellites 14 a, 14 b, 14 c, at a rate of 12/n or 24/n digits per satellite.

In accordance with the invention, the n satellites 14a, 14b, 14c are constituted by toothed wheels.

The toothed wheels are advantageously transparent. In the depicted examples, n being equal to 3, the toothed wheels are distributed uniformly at intervals of 120° about the axis A. The satellites 14a, 14b, 14c carry the hour digits distributed over the toothed wheels at a rate of four digits per toothed wheel. The satellite 14a carries the digits 1, 4, 7 and 10, the satellite 14b carries the digits 2, 5, 8 and 11 and the satellite 14c carries the digits 3, 6, 9 and 12, these digits being distributed angularly over each satellite at intervals of 90°. As illustrated as an example in the figures, it will be noted that the distribution of the hour digits over these satellites is such that all of the hour digits can be read chronologically there, one by one, when moving successively from one satellite to the other, in a same direction of rotation, after reading each digit.

In accordance with the invention, the satellites 14a, 14b, 14c are arranged to be continually rotated on themselves, about their own axis of rotation, in the opposite direction to the direction of rotation of the cage 3 and at a rotation speed with respect to the cage 3 which is different from the rotation speed of the cage 3 with respect to the display zone 2 by means of intermediate wheels carried by said cage 3, such as at least the reversing intermediate wheels 18, said intermediate wheels being arranged to be kinematically linked to a fixed wheel 20 with respect to said cage 3 and coaxial to the axis of rotation A of the cage 3.

According to the selected gear ratios, said intermediate wheels can comprise the n reversing intermediate wheels 18 arranged to cooperate with two successive satellites 14a, 14b, 14c, as well as a peripheral intermediate wheel 22 arranged to cooperate with the fixed wheel 20 and with one of the n reversing intermediate wheels 18, as depicted for example in FIG. 5. Thus, the peripheral intermediate wheel 22 makes the satellites 14a, 14b, 14c revolve by the intermediary of the reversing intermediate wheels 18.

In the case of the compact configuration, the reversing intermediate wheels 18 have a sufficient height in order to be able to mesh at least with two successive satellites 14a, 14b, 14c located at different heights.

The intermediate wheels can also only comprise the n reversing intermediate wheels 18 arranged to cooperate respectively with two successive satellites 14a, 14b, 14c and directly with the fixed wheel 20, as depicted for example in FIG. 1. The n reversing intermediate wheels 18 then serve directly as a peripheral intermediate wheel.

Each reversing intermediate wheel 18 is pivotally mounted within the cage 3, in particular between an arm 16 of the upper bridge 4 and a corresponding arm 16 of the lower bridge 6 of the cage 3. Thus, the reversing intermediate wheels 18 are located uniformly distributed about the axis of rotation A of the cage 3, a reversing intermediate wheel 18 being inserted between two of said satellites 14a, 14b, 14c.

In addition, when a peripheral intermediate wheel 22 is used, the latter is advantageously mounted integral in rotation with the reversing intermediate wheel 18 with which it is associated, under the lower bridge 6 of the cage 3, in particular under an arm 16.

The fixed wheel 20 is positioned under the cage 3, centred on the axis A of said cage 3. The fixed wheel 20 is integral with a frame element of the movement of the timepiece, and includes external peripheral teeth arranged to mesh either with the peripheral intermediate wheel 22 or directly with the reversing intermediate wheels 18.

In addition, in accordance with the invention, the rotation speed of each satellite 14a, 14b, 14c about its own axis of rotation with respect to the support member, here the cage 3, is selected so as to minimise the apparent angular displacement of said satellite 14a, 14b, 14c with respect to its own centre of rotation in the display zone 2 during the displacement, between the start and the end of the display zone 2, of said satellite led by the cage 3 itself in rotation about the axis A. The suitable rotation speeds of the satellites 14a, 14b, 14c and of the cage 3 are obtained by selecting the appropriate gear ratios.

Thus, the display zone 2 constitutes a first frame of reference in which each satellite 14a, 14b, 14c has an apparent speed which is a function of the rotation speed of the cage 3 with respect to this first frame of reference and of the rotation speed of the satellite 14a, 14b, 14c on itself with respect to the cage 3 which constitutes a second frame of reference. The rotation speed of the cage 3 in the first frame of reference and the rotation speed of the satellite 14a, 14b, 14c, about its own axis in the second frame of reference, are selected to give said satellite 14a, 14b, 14c in the first frame of reference the apparent speed corresponding to said desired minimised angular displacement in the display zone 2.

The rotation speed of the satellites 14a, 14b, 14c about their own axis of rotation with respect to the cage 3 is advantageously selected such that, during the displacement of one of said satellites 14a, 14b, 14c, led by the cage 3, between the start and the end of the display zone 2, the apparent speed of said satellite 14a, 14b, 14c in the first frame of reference is such that said apparent angular displacement of the hour digit carried by said satellite 14a, 14b, 14c in the display zone 2 is less than or equal to 30°.

Thus, by defining a vertical reading axis L, that is to say parallel to a conventional axis 12 hrs-6 hrs, in the display zone 2, and passing through the own centre of rotation of the satellite 14a, 14b, 14c which enters said display zone 2 (cf. FIGS. 1 to 3), said apparent angular displacement corresponds to the apparent inclination of angle α, with respect to said reading axis L, of the hour digit when it is displaced between the start and the end of said display zone 2. This inclination is maximal at the start and at the end of the display zone 2, while it is zero on the reading axis L. More specifically, it is thanks to an appropriate selection of the rotation speed of the satellite 14a, 14b, 14c on itself in the second frame of reference as a function of the rotation speed of the cage 3 in the first frame of reference that this maximal inclination can be minimised and in particular adjusted such that it does not exceed 30°.

For example, when n is equal to 3, the cage 3 makes one revolution in 3 hours in the clockwise direction, the rotation speed of the cage 3 being regulated by the motion work. The reversing intermediate wheels 18, and possibly the peripheral intermediate wheel 22, carried by the cage 3, revolve in the clockwise direction driven by the fixed wheel 20. Each of the three satellites 14a, 14b, 14c, carrying four digits as described above, driven by the reversing intermediate wheels 18, revolves on itself in the anticlockwise direction. The cage 3 and the satellites 14a, 14b, 14c, in particular their dimensions and the number of teeth, are configured such that the gear ratio between the cage 3, the intermediate wheels 18 and possibly 22, and the satellites 14a, 14b, 14c, is equal to ¼. Thus, each satellite 14a, 14b, 14c makes one revolution on itself in 4 hours in the anticlockwise direction in the second frame of reference constituted by the cage 3 but an hour digit carried by the satellite 14a, 14b, 14c takes 12 hours to find itself in the same position by simultaneously revolving about the axis of rotation A and about its own axis of rotation. During the displacement of the satellite 14a, 14b, 14c between the start and the end of the display zone 2, namely in one hour, the apparent angular displacement of the hour digit of said satellite 14a, 14b, 14c in the first frame of reference constituted by the display zone 2 is 30° in the clockwise direction because of the rotation of the cage 3 by 120° in the clockwise direction about the axis A in the first frame of reference and the rotation of the satellite on itself by 90° in the anticlockwise direction in the second frame of reference in one hour.

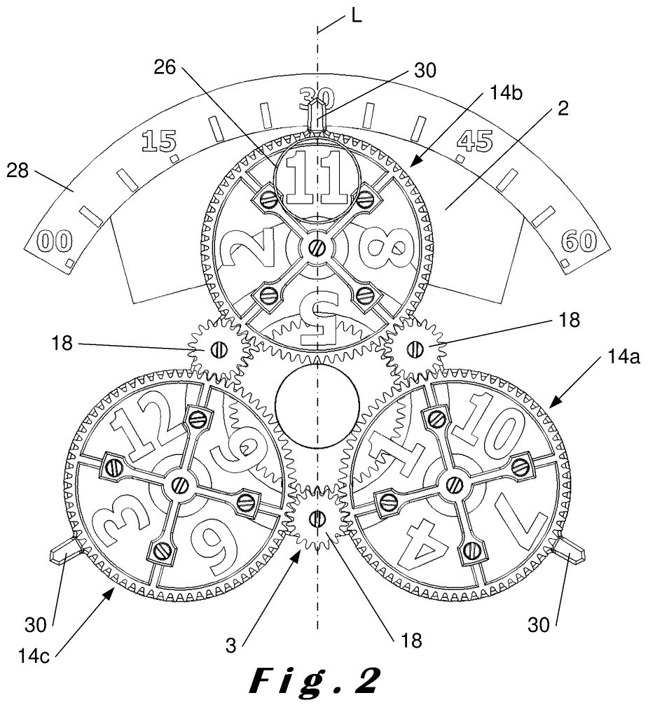

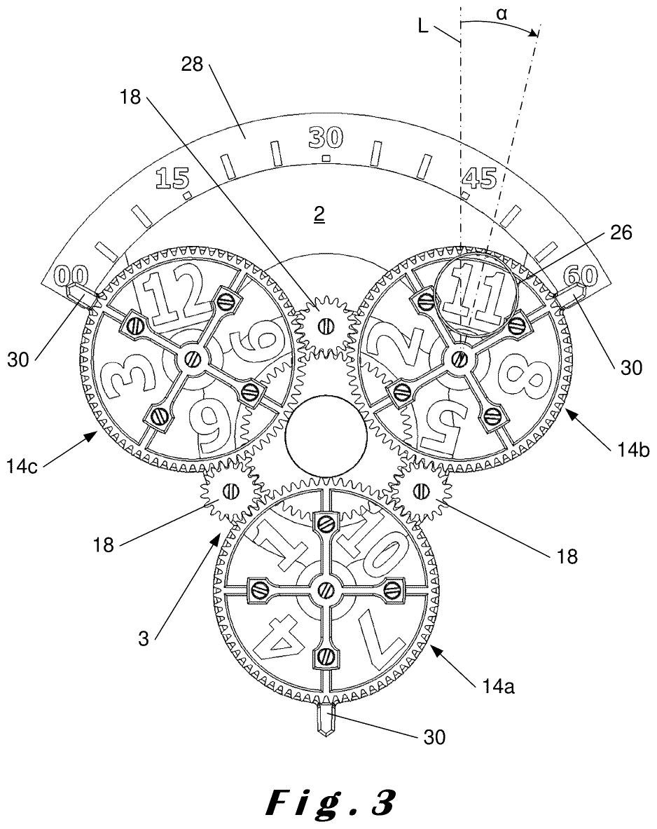

More specifically, with reference to FIG. 1, the satellites 14a, 14b, 14c are positioned such that it is the hour digit 11 carried by the satellite 14b which enters the display zone 2 to display 11 hours. The satellite 14b is positioned such that the digit 11 is inclined at an angle α of 15° in the anticlockwise direction with respect to the reading axis L. After 30 minutes, the cage 3 has revolved by 60° about the axis A in the clockwise direction in the first frame of reference constituted by the display zone 2 by displacing the satellite 14b in the display zone 2 as depicted in FIG. 2, said satellite 14b having also revolved on itself by 45° in the second frame of reference constituted by the cage 3 in the anticlockwise direction thanks to the reversing intermediate wheels 18 such that the apparent angular displacement of said satellite 14b with respect to its own centre of rotation in the display zone 2 is 15° (60°-45°) in the clockwise direction. The apparent inclination of the digit 11 with the reading axis L becomes zero. After another 30 minutes, namely after an hour, the cage 3 has again revolved by 60° about the axis A in the clockwise direction with respect to the display zone 2 by displacing the satellite 14b in the display zone 2 as depicted in FIG. 3, said satellite 14b having also again revolved on itself by 45° in the anticlockwise direction with respect to the cage 3 such that the apparent angular displacement of the hour digit carried by said satellite 14b with respect to its own centre of rotation in the display zone 2 is 15° in the clockwise direction. The apparent inclination of the hour digit 11 with the reading axis L is then at an angle α of 15° in the clockwise direction with respect to the reading axis.

Thus, the apparent angular displacement of the hour digit of the satellite 14b with respect to its own centre of rotation, in the display zone 2, is in total only 30° [−15; +15] in the clockwise direction in one hour while said satellite 14b, led by the cage 3, is displaced by 120° with respect to the display zone 2 in the clockwise direction about the axis A, between the start and the end of the display zone 2.

The time can therefore be read according to an up-down reading axis which remains substantially vertical, as depicted in the figures, such that reading the time is particularly ergonomic.

In parallel, the other satellites 14a and 14c, led by the cage 3, are also displaced by 120° with respect to the display zone 2 in the clockwise direction about the axis A in 1 hour, by revolving on themselves by 90° in the anticlockwise direction with respect to the cage 3, such that when the satellite 14b reaches the end of the display zone 2, the next satellite in the anticlockwise direction, here the satellite 14c, enters the display zone 2 to bring the next hour digit, the digit 12 appearing in the display zone 2 inclined at an angle α of 15° in the anticlockwise direction with respect to the reading axis L.

The cage 3 and the satellites 14a, 14b and 14c are located above the dial 1 comprising the display zone 2 arranged to be able to follow the trajectory of the hour digit to be displayed in order to indicate the time.

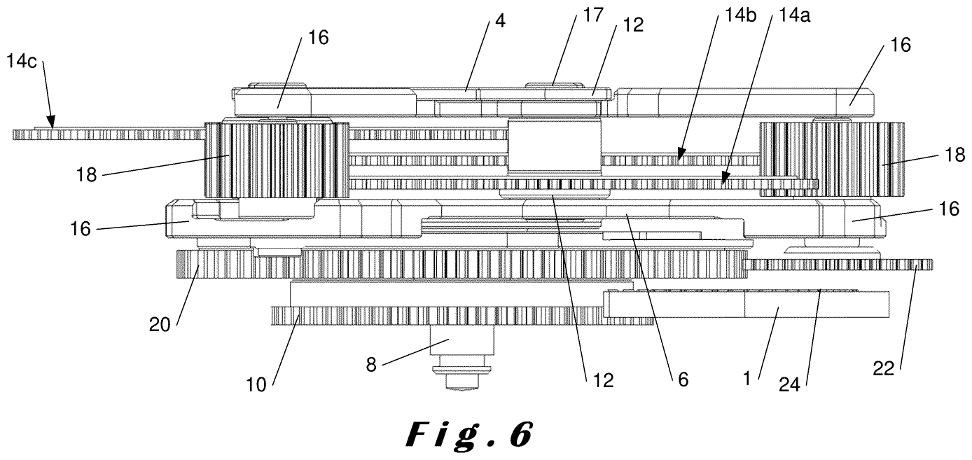

According to an embodiment depicted in FIGS. 5 and 6, the display zone 2 is arranged to constitute a fixed revealing device 24 to reveal the hour digit during its displacement between the start and the end of said display zone 2. For example, the fixed revealing device 24 can be constituted by a white circular sector depicted on the dial 1, the then transparent digits carried by the satellites 14a, 14b and 14c being of a contrasting colour in order to appear during their displacements above said white sector.

According to another embodiment depicted in FIGS. 1 to 3 and 8 to 11, the timepiece can comprise at least one mobile revealing device 26 arranged to follow and reveal the hour digit to be displayed during its displacement between the start and the end of the display zone 2. The mobile revealing device 26 can be placed under the satellites 14a, 14b and 14c which are then transparent or skeleton. The mobile revealing device 26 comprises, for example, a dot having a contrasting colour with respect to the colour of the digits depicted on said satellites 14a, 14b and 14c. The revealing device 26 can also be located above the digits.

The mobile revealing device 26 is arranged to pivot on itself by an angle identical to the apparent angular displacement of the satellite 14a, 14b and 14c with which it is associated, while being displaced in the display zone 2 at the same speed as the cage 3. For example, here, the mobile revealing device 26 revolves on itself by an angle of 30° in the clockwise direction while moving in the display zone 2 by an angle less than or equal to 120° with respect to the axis A in the clockwise direction in one hour. The point of rotation of the mobile revealing device 26 is therefore variable, being off-centred with respect to the axis A of the cage 3, as shown in FIGS. 1 to 3. The mobile revealing device 26 is arranged to follow an hour digit for 1 hour, then once the sixtieth minute is arrived at, to be instantly displaced in order to display the next hour digit.

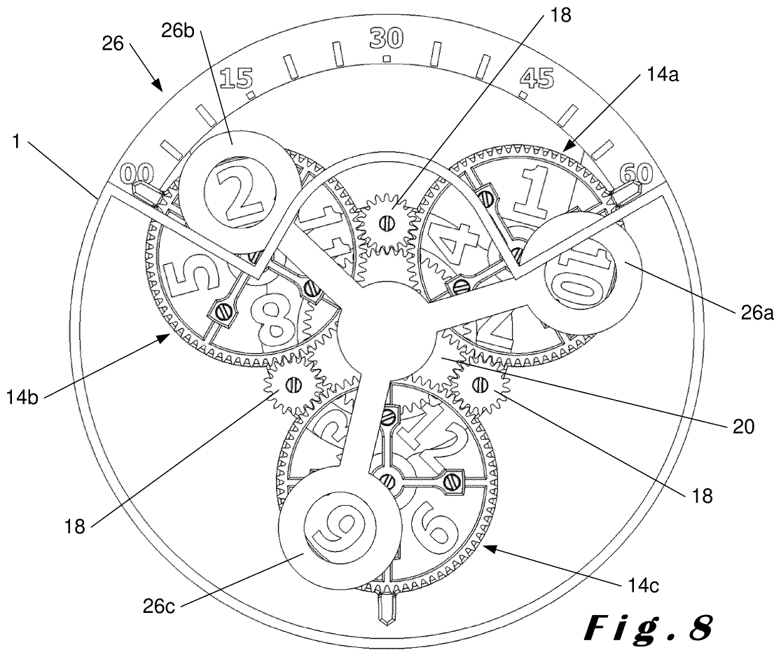

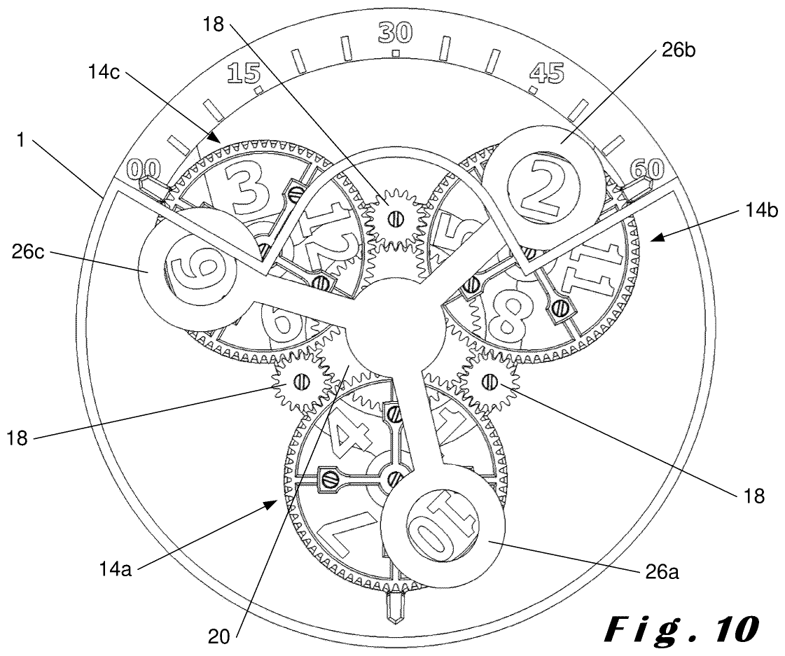

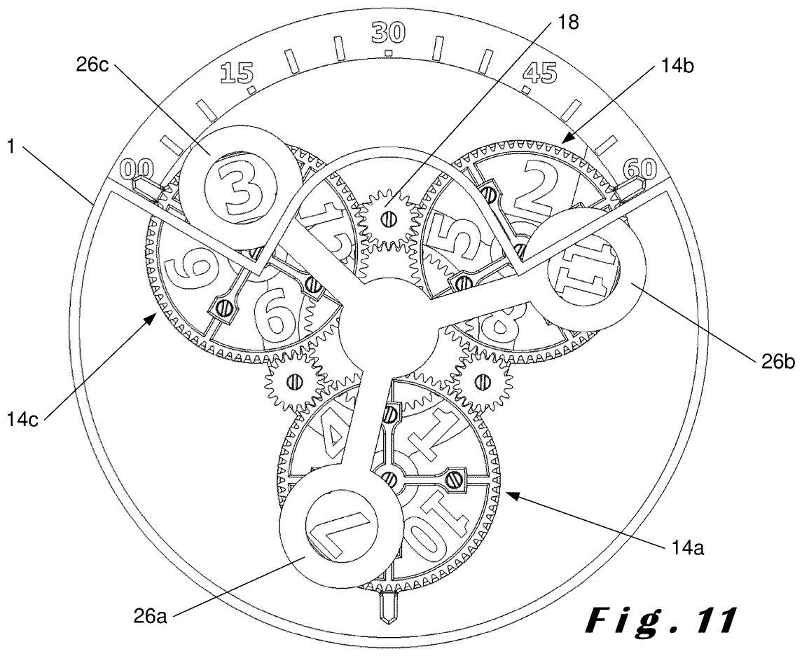

The mobile revealing device 26 can be arranged to jump in the same direction of rotation as that of the cage 3. In this case, it is possible to provide a mobile revealing device 26 having several revealing faces, that is to say including several revealing zones or surfaces, sequenced, as depicted in FIGS. 8 to 11, in order to reduce the angle of displacement of the mobile revealing device at each jump. Said mobile revealing device 26 has, for example, three revealing faces 26a, 26b, 26c, associated respectively with a satellite 14a, 14b, 14c. Here the face 26b of the mobile revealing device 26 follows the digit 2 carried by the satellite 14b, the other faces 26a and 26c following the digits 10 and 6 carried respectively by the other satellites 14a and 14c, when said satellites 14a, 14b, 14c are displaced with the cage 3. After one hour, when the digit 2 and the associated face 26b of the mobile revealing device 26 have reached the end of the display zone 2, as depicted in FIG. 10, the mobile revealing device 26, having arrived at the sixtieth minute, is arranged to jump in rotation in the clockwise direction so that the next face in the anticlockwise direction, here the face 26c, instantly comes to reveal the next digit to be displayed, carried by the satellite, entering the display zone 2, here the digit 3 carried by the satellite 14c, as depicted in FIG. 11.

The mobile revealing device 26 can also be arranged to have a retrograde movement in the direction of rotation opposite that of the cage 3, once the displayed digit and the mobile revealing device 26 have reached the end of the display zone 2. In this case, the mobile revealing device 26 can be wider than the hour digit with a speed of displacement in the display zone 2 which is less rapid than the hour digit in order to reduce the angle of displacement of the revealing device 26 in the display zone 2.

In a preferred embodiment, the time display mechanism also makes it possible to display the minutes. To that end, the timepiece comprises, on the dial 1, a scale 28 which is graduated in minutes, from 0 to 60, extending over an arc of a circle of 360°/n, here 120°, centred on the axis of rotation A of the cage 3, and located above the hour display zone 2, as depicted in FIGS. 1 to 3.

The minutes can be indicated in several ways by using the difference in rotation speed between the cage 3 and the satellites 14a, 14b, 14c.

For example, taking the cage 3 as a reference, the cage 3 can comprise at least one indicating member arranged to indicate the minute on the scale which is graduated in minutes 28. Advantageously, n indicating members 30 are provided (cf. FIGS. 1 to 3) uniformly distributed over the cage 3 and associated respectively with one of the n satellites, said indicating members 30 being arranged to indicate the minute on the scale which is graduated in minutes 28. Thus, during the rotation of the cage 3, the hour digit carried by a satellite 14a, 14b, 14c is displayed and is displaced in the display zone 2 to indicate the hour and the corresponding indicating member 30 carried by the cage 3 is displaced successively facing the graduations of the scale 28 to indicate the minutes.

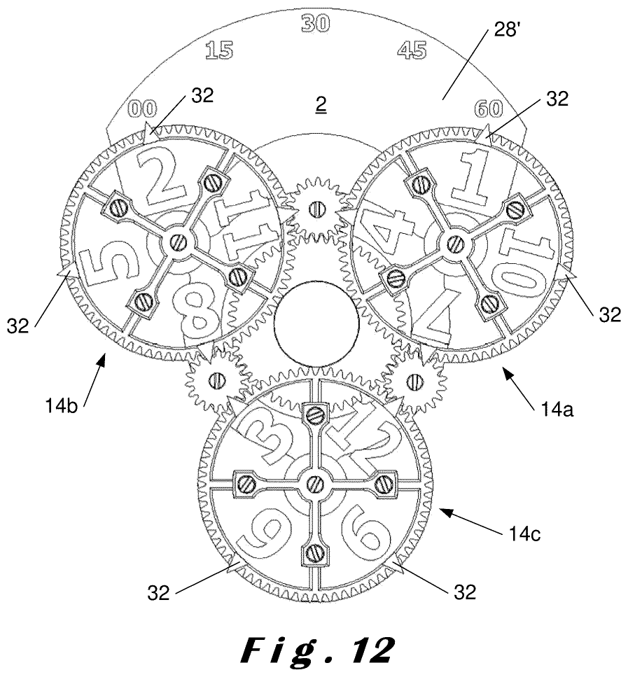

Taking the displacement of the satellites 14a, 14b, 14c as the reference, each satellite 14a, 14b, 14c can comprise an indicating member 32 associated with each hour digit and arranged to indicate the minute on an appropriate scale which is graduated in minutes 28′ as a function of the apparent displacement of the satellite 14a, 14b, 14c in the display zone 2, as shown in FIG. 12. The indicating member 32 has the same minimised apparent inclination as its hour digit during the displacement of the satellite in the display zone 2, such that the apparent inclination of the indicating member 32 with respect to the minute scale 28′ is also minimised.

The embodiments described are of course subject to numerous variations. For example, the graduation of the minutes could be on the glass or on the bezel.

The rotation speed of the cage and the satellites, the number of satellites, the number of digits per satellite and the size of the display zone could be different. These quantities are, however, interdependent. Generally, for a display of hours from 1 to 12, if the cage 3 performs one revolution in n hours (n being a whole number greater than 1), it will carry n satellites and the hour digits will be distributed over these satellites at a rate of 12/n digits per satellite, and the minute scale will extend over an arc of a circle of 360°/n. If the hours are displayed from 1 to 24, the hour digits will have to be distributed at a rate of 24/n digits per satellite. The gear ratios will be selected as a function of the rotation speeds of the cage and the satellites in order to minimise the apparent inclination of the hour digits carried by the satellites when they are displaced with the cage. The number of satellites is not limited to three, but the configuration with three satellites makes it possible to maximise the size of the hour digits on the satellites.

The invention makes it possible to obtain a timepiece comprising a dynamic time display while making it possible to read the time in an ergonomic manner, the apparent inclination of the hour digit varying very little between the start and the end of its display. It also makes it possible not to generate a disruptive torque and to smooth the torque transfer of the mechanism, the force to revolve the satellites which permanently mesh being continuous.

The configuration of the time display mechanism according to the invention is not limited to the example described. It is obvious that any other appropriate support member, different from a cage comprising two bridges, can be used. In particular, the support member can be an open cage, only one bridge being used. For example, it is possible to provide only the upper bridge of the cage, the satellites and the intermediate wheels being mounted suspended from the arms of this bridge. Likewise, the use of arms for carrying the satellites and the intermediate wheels is a particularly advantageous embodiment if it is desired that the satellites are clearly visible, but any other appropriate bridge configuration can be used.

1. A timepiece comprising:
a time display mechanism comprising
a support member rotatable about an axis of rotation and configured to perform one revolution in n hours, n being a whole number greater than 1, and carrying n satellites each rotatably mounted on its own axis of rotation, located uniformly distributed about the axis of rotation of the support member and carrying the hour digits, distributed over said satellites at a rate of 12/n or 24/n digits per satellite, and
a time display zone extending over a circular sector of at least 360/n° centered on the axis of rotation of the support member,
wherein the hour digits are successively displaced in order to appear in the time display zone,
the satellites are constituted by toothed wheels and are configured to be continually rotated on themselves about their own axis of rotation in the opposite direction to a direction of rotation of the cage and at a different rotation speed to the rotation speed of the cage by intermediate wheels carried by said cage and configured to be kinematically linked to a fixed wheel with respect to said cage and coaxial to the axis of rotation of the cage, the rotation speed of each of the satellites about its own axis of rotation with respect to the cage being selected so as to minimize an apparent angular displacement of said respective satellite with respect to its own center of rotation in the time display zone during the angular displacement of said respective satellite led by the cage between a start and an end of said time display zone.

2. The timepiece according to claim 1, wherein the rotation speed of the satellites about their own axis of rotation with respect to the cage is selected such that, during the angular displacement of one of the satellites led by the cage between the start and the end of the display zone the apparent angular displacement of said satellite with respect to its own center of rotation in the time display zone is less than or equal to 30°.

3. The timepiece according to claim 1, further comprising a motion work configured to drive the cage.

4. The timepiece according to claim 1, wherein the satellites are disposed in a partially superimposed manner with respect to one another.

5. The timepiece according to claim 1, wherein the satellites are arranged on a same level.

6. The timepiece according to claim 1, wherein the intermediate wheels comprise n reversing intermediate wheels respectively configured to cooperate with two successive ones of the satellites and a peripheral intermediate wheel configured to cooperate with the fixed wheel and one of the n reversing intermediate wheels.

7. The timepiece according to claim 1, wherein the intermediate wheels comprise n reversing intermediate wheels respectively configured to cooperate with two successive one of the satellites and the fixed wheel.

8. The timepiece according to claim 1, wherein n is equal to 3, each of the three satellites carrying four digits, a gear ratio between the cage and the satellites being equal to ¼, such that, during the angular displacement of one of the satellites led by the cage between the start and the end of the time display zone, the apparent angular displacement of said satellite about its own center of rotation in the time display zone being 30°.

9. The timepiece according to claim 1, further comprising a scale which is graduated in minutes extending over an arc of a circle of 360/n° centered on the axis of rotation of the cage.

10. The timepiece according to claim 9, wherein the cage comprises at least one indicator configured to indicate the minute on the scale which is graduated in minutes.

11. The timepiece according to claim 9, wherein each of the satellites comprises an indicator associated with each hour digit and configured to indicate the minute on the scale which is graduated in minutes.

12. The timepiece according to claim 1, wherein the time display zone is configured to constitute a fixed revealing device to reveal the hour digit during its displacement between the start and the end of said time display zone.

13. The timepiece according to claim 1, further comprising at least one mobile revealing device configured to follow and reveal the hour digit to be displayed during its displacement between the start and the end of the time display zone.

14. The timepiece according to claim 13, wherein the mobile revealing device is configured to jump in a same direction of rotation as the direction of rotation of the cage.

15. The timepiece according to claim 13, wherein the mobile revealing device is configured to have a retrograde movement in a direction of rotation opposite the direction of rotation of the cage.
